(19) United States
(12) Patent Application Publication
(10) Pub. No.: US 2013/0126490 A1
(43) Pub. Date: May 23, 2013

(54) LARGE-AREA MASK CLEANING APPARATUS USING LASER AND LARGE-AREA MASK CLEANING SYSTEM INCLUDING THE SAME

(71) Applicant: IMT CO., LTD., Uiwang-si (KR)

(72) Inventors: Jong Myoung LEE, Anyang-si (KR); Jin Bae KIM, Gunpo-si (KR)

(73) Assignee: IMT CO., LTD., Uiwang-si (KR)

(21) Appl. No.: 13/670,862

(22) Filed: Nov. 7, 2012

(30) Foreign Application Priority Data
Nov. 17, 2011 (KR) 10-2011-0119945

(51) Int. Cl. B23K 26/00

(52) U.S. Cl. 219/121.68

(57) ABSTRACT

A laser cleaning apparatus for removing a surface pollutant on a large-area mask uniformly over an entire surface thereof is disclosed. The laser cleaning apparatus includes a laser generator; and a laser scanner for receiving a laser beam from the laser generator and scanning a surface of the mask with the laser beam using a movable end scanning mirror. The laser scanner includes a distance compensation device for maintaining a constant transmission distance of the laser beam between the lager generator and the surface of the mask.

### CROSS-REFERENCE TO RELATED APPLICATION

This application claims priority under 35 U.S.C. §119(a) to Republic of Korea Patent Application No. 10-2011-0119945, filed on Nov. 17, 2011, which is incorporated herein by reference

### BACKGROUND OF THE INVENTION

1. Field of the Invention

The present invention relates to a large-area mask cleaning apparatus using a laser and a large-area mask cleaning system including the same.

2. Description of the Related Art

Generally, a precise mask is a key component for forming a specific precise pattern on a base material substrate in a flat panel display and semiconductor industry. Specifically, in order to pattern an organic film on the substrate in a manufacturing process of an organic electroluminescent display, a precisely patterned mask should be very closely adjacent to the substrate or come into contact with the substrate, so that the pattern shape on the mask may be transferred as it is in a one-to-one relationship, thereby performing a patterning on the substrate. Additionally, in order to protect the patterned organic film formed as described above, an acrylic material may be applied. Even in this case, a precise contact open mask may be used to apply a protective layer in a roll print manner or in a deposition manner.

At this time, an Invar (Fe—Ni alloy) or SUS (stainless steel) material which is rarely thermal-expanded but highly corrosion-resistant and durable may be used as a mask material, which commonly has a thickness of 200 mm or less. Since the manufacturing cost of the ultrafine pattern mask manufactured as described above is very high, a pollutant layer attached to a surface of the mask after every use is cleaned away, and then, the cleaned mask is reused.

In case of the precise pattern mask used in a conventional manufacturing process of a flat panel display, a chemical wet cleaning method using a strong acid or base solution is used to melt and remove the pollutant on the surface of the mask. However, the currently used chemical wet cleaning method cannot provide a complete cleaning due to the latest ultrafine tendency of the mask pattern, so that a number of defective products may be manufactured. Specifically, it usually takes at least 24 hours to clean one mask, which results in a large problem in view of a manufacturing effectiveness. Additionally, since a toxic chemical solution such as a strong acid or alkaline solution is used, there are problems in that the working environment is very poor; a huge post-process cost and an additional waste water treatment are required; a long recycling time due to a long cleaning time causes a stock of a number of expensive masks to be secured; and an urgent cleaning request cannot be responded.

In order to resolve the above-mentioned problems, the inventor of the present invention has proposed a cleaning method and apparatus as disclosed in Korean Patent No. 10-0487834. In the disclosed technique in which a laser and an ultrasonic wave are simultaneously used, a conveyer system is used to selectively remove only pollutants on a surface very fast without damaging a base material of a precise pattern mask.

Recently, the size of a mask used in a manufacturing process of a display has been rapidly increased to be more than 1 m. If the mask would be scanned with a laser beam over the entire surface in order to clean such a precise large-area mask, the laser beam should be spaced far away from the laser generator. At this time, since every laser beam has a divergent angle to some extent, the cross-sectional area of the laser beam is gradually increased as the distance between the laser beam and the laser generator is increased.

FIG. 1 shows the propagation of a conventional laser beam. As shown in the figure, as the distance is increased, the cross-sectional area of the laser beam is enlarged from A1 to A2. When the laser cleaning is performed, energy per unit area, i.e., energy density, is a very important factor which influences the effectiveness of the laser cleaning As described above, since the cross-sectional area of the laser beam is enlarged depending on the distance, the energy density is reduced as the distance is increased, so that it would be difficult to secure sufficient cleaning capability.

Accordingly, when such a large-area mask may be scanned at a long distance with a laser beam, there is a problem in that the difference between energy densities at near and distant locations results in non-uniform laser cleaning Further, there is also a problem in that a cleaning apparatus should be unnecessarily enlarged when the large-area mask should be horizontally laid to be moved on a conveyer.

### SUMMARY OF THE INVENTION

An object of the present invention is to provide a large-area mask cleaning apparatus using a laser and a system including the same to solve the aforementioned problems in the prior art.

Another object of the present invention is to provide an apparatus capable of precisely cleaning a large-area mask by solving a non-uniform cleaning problem which could occur by a change in energy per unit area, i.e., energy density, of a laser beam due to the divergence of the laser beam and the resulting change in a spot-size of the laser beam when cleaning a large-area surface using a laser.

A further object of the present invention is to provide a large-area mask cleaning system in which its size may be totally reduced and a large-area mask may be precisely cleaned by a cleaning apparatus using a laser.

According to an aspect of the present invention, there is provided a laser cleaning apparatus for removing a surface pollutant on a large-area mask uniformly over an entire surface thereof, which includes a laser generator; and a laser scanner for receiving a laser beam from the laser generator and scanning a surface of the mask with the laser beam using a movable end scanning mirror. The laser scanner includes a distance compensation device for maintaining a constant transmission distance of the laser beam between the lager generator and the surface of the mask.

According to an embodiment of the present invention, the laser scanner may include an intermediate mirror for leading the laser beam from the laser generator to the distance compensation device; and another intermediate mirror for leading the laser beam from the distance compensation device to the end scanning mirror.

According to an embodiment of the present invention, the distance compensation device may include a pair of movable mirrors.

According to another aspect of the present invention, there is provided a large-area mask cleaning system, which includes a laser cleaning apparatus between a mask loading position and a mask unloading position; and a gantry robot for transferring a mask while the mask is erected vertically.

According to an embodiment of the present invention, the large-area mask cleaning system may further include an ultrasonic cleaning apparatus and a rinsing-drying processing apparatus in order after the laser cleaning apparatus, wherein the gantry robot always maintains the mask to be erected vertically while the gantry robot transfers the mask to the laser cleaning apparatus, the ultrasonic cleaning apparatus and the rinsing-drying processing apparatus.

According to an embodiment of the present invention, the gantry robot includes a mask holding unit for holding the mask to be erected vertically and transferring the mask upwards or downwards; and a guide rail for moving the mask holding unit in a straight line.

### BRIEF DESCRIPTION OF THE DRAWINGS

FIG. 1 is a view illustrating a prior art;

FIG. 2 is a view illustrating a large-area mask cleaning apparatus using a laser according to an embodiment of the present invention; and

FIG. 3 is a view illustrating a cleaning system including the large-area mask cleaning apparatus as shown in FIG. 2.

### DESCRIPTION OF THE PREFERRED EMBODIMENT

Hereinafter, a preferred embodiment of the present invention will be described in detail with reference to the accompanying drawings.

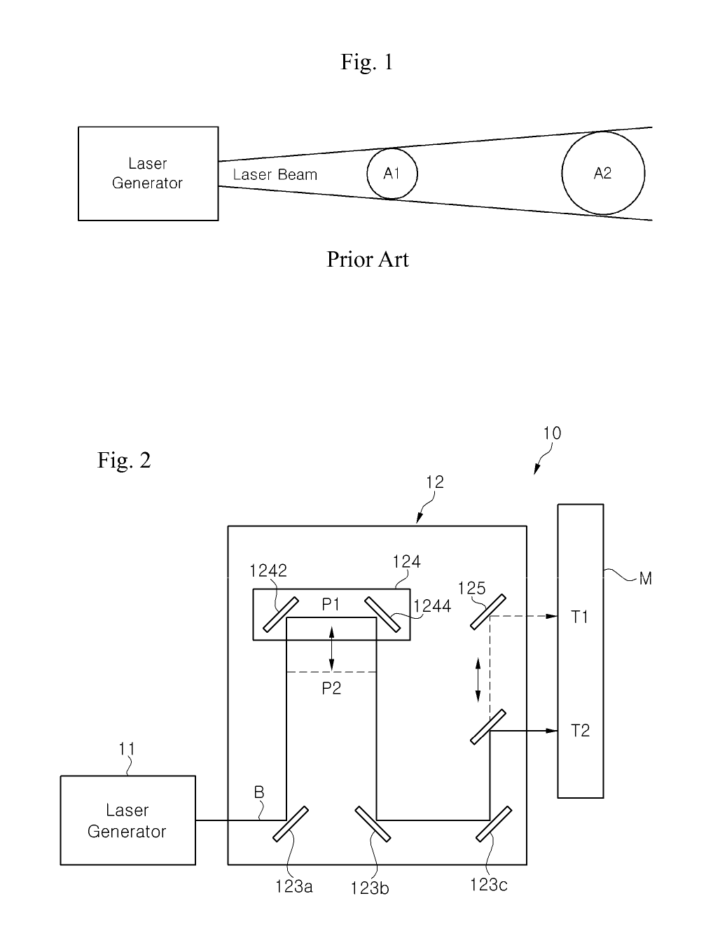

FIG. 2 is a view illustrating a laser cleaning apparatus according to an embodiment of the present invention.

Referring to FIG. 2, a laser cleaning apparatus 10 according to this embodiment includes a laser generator 11 and a laser beam scanner 12. The laser beam scanner 12 has intermediate mirrors 123a, 123b and 123c, a distance compensation device 124, and an end scanning mirror 125.

A laser beam B generated from the laser generator 11 is guided onto a surface of a large-area mask M which is an objective to be cleaned, wherein the end scanning mirror 125 scans the mask M using a motor (not shown) in order to clean the entire surface of the mask M. At this time, when the end scanning mirror 125 is moved, the distance from the laser generator 11 to a laser illuminated surface of the mask M is varied.

In order to eliminate such a variation in the transmission distance of the laser beam, the distance compensation device 124 is installed within the laser beam scanner 12. The distance compensation device 124 is composed of two mirrors 1242 and 1244 paired with each other. The pair of mirrors 1242 and 1244 is configured to be moved in an axial direction by driving a motor (not shown).

That is, in order to compensate for the increase of the total transmission distance of the laser beam as the end scanning mirror 125 scans from a position T1 to a position T2, the distance compensation device 124 is moved from a position P1 to a position P2 as far as a distance difference. As a result, in order to maintain a constant distance when the end scanning mirror is transferred for a scanning process, the distance compensation device 124 is also correspondingly moved in a reverse direction.

Accordingly, the distance compensation device 124 may be used to always maintain a constant distance during the scanning of the large-area mask M, so that the constant energy density of the laser beam may be maintained. As a result, there is an advantage in that a uniform laser cleaning result may be obtained.

According to this embodiment, the intermediate mirrors 123a, 123b and 123c are fixed at their predetermined positions, respectively.

One intermediate mirror 123a of the intermediate mirrors 123a, 123b and 123c is used to lead the laser beam B generated from the laser generator 11 to the distance compensation device 124. The laser beam which has passed through the pair of mirrors 1242 and 1244 in the distance compensation device 124 is led to a surface of the large-area mask M by the other intermediate mirrors 123b and 123c of the intermediate mirrors 123a, 123b and 123c. As described above, when the end scanning mirror 125 scans from the position T1 to the position T2, the distance compensation device 124 is moved as far as the aforementioned distance difference together with the pair of the mirrors 1242 and 1244, thereby compensating for the increase of the total transmission distance of the laser beam.

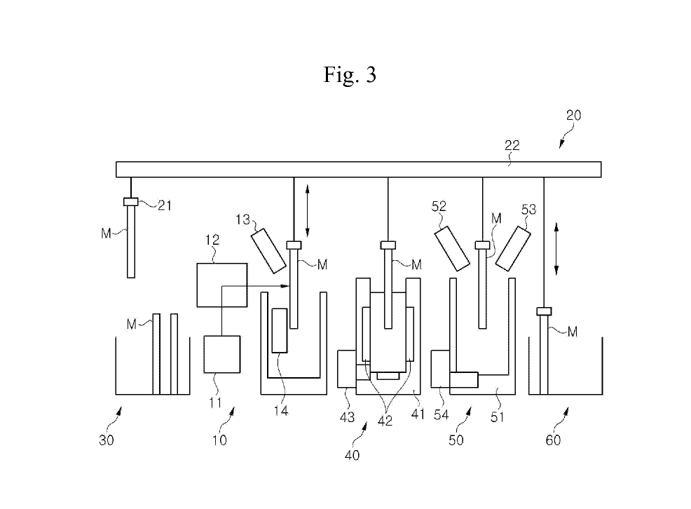

FIG. 3 is a view illustrating a large-area mask cleaning system to which the laser cleaning apparatus as described above is applied.

As described in the prior art, a mask cleaning apparatus to which a conveyer system is applied is disclosed in Korean Patent No. 10-0487834. However, when a mask is increased in size, the cleaning apparatus is much enlarged. As a result, there is a disadvantage in that the mask cleaning apparatus is very disadvantageous in view of the spatial issue.

The large-area mask cleaning system according to this embodiment to solve the aforementioned problem is configured to erect the mask vertically and to use a gantry robot 20 to transfer the mask. A robot capable of moving the mask in a left-right direction (x-direction) and a vertical direction (z-direction) is used as the gantry robot 20. The gantry robot 20 includes a mask holding unit 21 for grasping an end of the mask 10 to hold the mask 10; and a guide rail 22 for moving the mask holding unit 21 in a straight line. The mask holding unit 21 is configured so that the height may be adjusted by the upward and downward movement thereof

The system according to this embodiment includes a mask loading cassette apparatus 30 capable of loading the masks M one after another by means of the gantry robot 20, the laser cleaning apparatus 10, an ultrasonic processing apparatus 40, a rinsing-drying processing apparatus 50, and a mask unloading cassette apparatus 60 in order.

As described above, the laser cleaning apparatus 10 includes the laser generator 11 and the laser beam scanner 12. The laser cleaning apparatus 10 further includes an air injection nozzle 13 for blowing pollutants detached during the laser cleaning process off in one direction, and a suction apparatus 14 for collecting the pollutants.

The ultrasonic processing apparatus 40 is positioned after the laser cleaning apparatus 10, and includes an ultrasonic processing bath 41, an ultrasonic transducer 42 positioned within the ultrasonic processing bath 41, a water circulation apparatus 43 for effectively feeding and discharging water into and out of the ultrasonic processing bath 41.

The rinsing-drying processing apparatus 50 includes a rinsing processing bath 51, a liquid injection nozzle 52 for injecting ultrapure water, alcohol, or the like, and an air injection nozzle 53 for injecting hot air in order to dry the mask M after the rinsing process. Additionally, the rinsing-drying processing apparatus 50 may further include a water circulation apparatus 54.

The mask unloading cassette apparatus 60 includes a cassette from which the masks M passing through the apparatuses described above are unloaded.

While the mask M is sequentially moved from the mask loading cassette apparatus 30 to the mask unloading cassette apparatus 60 through the laser cleaning apparatus 10, the ultrasonic processing apparatus 40 and the rinsing-drying processing apparatus 50, the gantry robot 20 allows the mask M to be maintained to be vertically erected, so that there is an advantage in that the size of the cleaning system can be considerably reduced.

The present invention may be specifically applied to the fields as follows:
1. A manufacturing process of a flat panel display including an organic light emitting diode.
2. All the manufacturing industries using precise masks.

According to the present invention, with the technique in which a laser is used to scan and clean a large-area objective, a non-uniform laser cleaning capability can be overcome which could occur from a change in energy density in an objective surface due to a long distance and the resulting divergence of the laser beam. Additionally, the size of the cleaning system (or apparatus) can be decreased through the vertical transfer and cleaning processes of the mask using a gantry robot.

As described above, the aforementioned descriptions are merely exemplary preferred embodiments of the present invention. It will be apparent that those skilled in the art can make various modifications and changes thereto without changing the scope of the invention defined by the claims.

What is claimed is:

1. A laser cleaning apparatus for removing a surface pollutant on a large-area mask uniformly over an entire surface thereof, comprising:
a laser generator; and
a laser scanner for receiving a laser beam from the laser generator and scanning a surface of the mask with the laser beam using a movable end scanning mirror,
wherein the laser scanner includes a distance compensation device for maintaining a constant transmission distance of the laser beam between the lager generator and the surface of the mask.

2. The laser cleaning apparatus according to claim 1, wherein the laser scanner comprises:
an intermediate mirror for leading the laser beam from the laser generator to the distance compensation device; and
another intermediate mirror for leading the laser beam from the distance compensation device to the end scanning mirror.

3. The laser cleaning apparatus according to claim 1 or 2, wherein the distance compensation device comprises a pair of movable mirrors.

4. A large-area mask cleaning system, comprising:
a laser cleaning apparatus between a mask loading position and a mask unloading position; and
a gantry robot for transferring a mask while the mask is erected vertically.

5. The large-area mask cleaning system according to claim 4, further comprising an ultrasonic cleaning apparatus and a rinsing-drying processing apparatus in order after the laser cleaning apparatus, wherein the gantry robot always maintains the mask to be erected vertically while the gantry robot transfers the mask to the laser cleaning apparatus, the ultrasonic cleaning apparatus and the rinsing-drying processing apparatus.

6. The large-area mask cleaning system according to claim 4, wherein the gantry robot comprises:
a mask holding unit for holding the mask to be erected vertically and transferring the mask upwards or downwards; and
a guide rail for moving the mask holding unit in a straight line.
